(19) United States
(12) Patent Application Publication
(10) Pub. No.: US 2014/0326656 A1
(43) Pub. Date: Nov. 6, 2014

(54) DIATOMACEOUS EARTH FILTER CLEANING TOOL WITH FLUID OSCILLATION NOZZLE AND DIATOMACEOUS EARTH CAPTURING SYSTEM

(71) Applicant: AMAYZEUM, LLC, Plano, TX (US)

(72) Inventors: STEVEN R. GREENFIELD, PLANO, TX (US); BRENT ROARK, FLOWER MOUND, TX (US)

(21) Appl. No.: 14/216,694

(22) Filed: Mar. 17, 2014

Related U.S. Application Data
(60) Provisional application No. 61/793,973, filed on Mar. 15, 2013.

(51) Int. Cl. B01D 29/68; B01D 29/27

(52) U.S. Cl. CPC B01D 29/68; B01D 29/27
USPC 210/460; 134/191

(57) ABSTRACT

Embodiments provide a pool filter cleaning system that comprises an elongate tube having a first end, a second end and length in a longitudinal direction; a hose connector configured to connect to a supply of water under pressure, the hose connector is attached to the first end of the elongate tube. A spray nozzle is located at the second end of the elongate tube such that an outer surface of the spray nozzle and the elongate tube establish a substantially smooth continuous outer surface. The spray nozzle of an exemplary pool filter cleaning system comprises at least one water oscillation chamber configured to oscillate or pulsate fluid flow through the spray nozzle such that fluid output from a plurality of spray nozzle fluid outputs is oscillated or pulsated at a sonic frequency and in directions that have both a radial component and a longitudinal component away the second end.

### CROSS-REFERENCE TO RELATED APPLICATIONS

This application claims benefit of U.S. Provisional Application No. 61/793,973, filed Mar. 15, 2013, entitled DIATOMACEOUS EARTH FILTER CLEANING TOOL WITH FLUID OSCILLATION NOZZLE AND DIATOMACEOUS EARTH CAPTURING SYSTEM (Atty. Dkt. No. AMNZ-31575), which is herein incorporated by reference in its entirety.

### TECHNICAL FIELD

Embodiments of the invention relate to a pool filter cleaning device, system and method. More particularly, embodiments of the invention relate to a cleaning apparatus for pool filters and a pool filter drain discharge apparatus for containing post filter DE debris discharged from a pool filter drain outlet during use of an exemplary cleaning method.

### BACKGROUND

Diatomaceous earth (“DE”) filters are often used to filter swimming pool water, spas, water fountains and other water related circulation systems. DE filters typically include a septum or woven porous material with a relatively large porosity that DE cannot pass through. Adding a solution of water and DE to the filter forms a cake of DE on the surface of the septum. The addition of the DE to the septum creates a structure having a smaller porosity, which improves the filtering capability of the septum. However, over time contaminants caught in the DE reduce the DE-septum filtering capability by clogging the established smaller porosity. As a result, the DE must be periodically removed from the septum material and reapplied. Various methods, techniques and apparatus have been used to remove DE from the outer septum surfaces of DE filter tubes, DE filter cartridges and DE filter element grids. One important concern, when using any technique or apparatus to clean DE and other debris from the septum of a pool filter, is not to damage, tear or cause excessive wear to the septum material during the cleaning process. If the septum is damaged or weakened during the cleaning process, DE may be pumped through the damaged portion of the septum (rather than being caked on the outer surface of the septum) and into the pool.

FIGS. 1A, 1B and 1C depict examples of an existing DE pool filter, being a vertical grid DE filter system that utilizes DE filter element grids 12. In each of this typical DE pool filter, a DE solution is caked on the outer surface or septum of the filter element grids. Furthermore, in each of these typical DE pool filters it is important not to damage, rip or weaken the septum material covering the DE grids 12 when cleaning the DE and debris from the surface of the septum material.

Referring to FIG. 1C, an exploded view of a typical vertical grid DE filter 10 is depicted. When a vertical DE filter 10 is manually cleaned, it is done to not only remove the cake of DE and contaminants, but also to deep clean the porous septum material that is part of and about the exterior of each of the filter element grids 12. A normal manual cleaning procedure generally proceeds as follows:

1. Shut off the pool pump (not specifically shown).

2. Open an air-relief valve 14 and remove the drain plug 16 or open the waste valve (not specifically shown). At this point the water held within the filter head or tank lid 18 and lower filter body 20 will drain out of the inner cavity created within the filter head 18 and lower filter body 20.

3. Remove the tank clamp assembly 28 by, for example, undoing the nuts or bolts (30, 32) depending on the vertical DE filter model. After the tank clamp assembly 28 is removed, then the tank lid 18 can be removed.

4. The spreader or manifold 22 may then be removed by, for example, removing the nut 24 and washer 26. Then each filter grid element 12 is lifted out of the filter body separately. Each filter element or cartridge element (depending on the type of DE filter in use) may then be removed from the filter body 20 and individually separated from the filter grid assembly 29 in preparation for cleaning.

5. Each separate filter grid element 12 can then be sprayed individually with a garden hose to wash off and remove the contaminated diatomaceous earth (DE) from each separated filter grid septum surface. The hose may then be used to hose out the interior of the filter tank's filter body interior so that any remaining contaminated DE within the filter body 20 is flushed out of the bottom drain hole 17. The contaminated DE may be washed onto the ground surrounding or about the vertical DE filter leaving an unsightly coating of contaminated DE on the ground surfaces about the DE vertical filter.

6. The rinsed filter grids are then individually and carefully aligned and replaced back into the manifold 22 such that they are each firmly seated in place. At the same time, the filter grids 12 must be carefully aligned in the filter element locator 23 while the washer 26 and nut 24 are replaced on the top of the retainer rod 25 so that the whole of the filter grid/manifold/filter element locator assembly (the “filter grid assembly”) 29 is held together. This process is often both frustrating and results in the individual filter grid septum surfaces to rub against each other, the filter element locator and retainer rod thereby causing wear and tear damage tears to the individual filter grids and potential tears to their septum coverings and surfaces.

7. The filter grid assembly 29 is then placed and aligned inside the filter body 20 such that the manifold 22 is properly connected to the output elbow tube 36.

8. Next the filter tank O-ring 38 may be lubricated with a petroleum jelly or silicon based lubricant and placed about the top of the filter body 20. The tank lid or filter head 18 is then replaced back on top of the filter body 20 and the tank clamp assembly 28 is replaced about the seam between the filter head 18 and the filter body 20. The tank clamp bolt 32 is tightened to create a watertight seal between the filter head 18 and the lower filter body 20.

9. Finally, the drain plug 16 is reinstalled into the drain hole 17.

10. Now, filter type and make specific procedures are followed to refill the vertical DE filter with water and recoat the filter grids' septum with a fresh new coating of DE solution.

The above process of cleaning the contaminated DE from the outer septum surfaces of the multiple grid filters, one at a time, can take from about an hour by an experienced pool filter technician to about four to six or more frustrating hours by a person who cleans a vertical DE filter about 2-3 times a year. The process of removing the individual filter grids 12, positioning each individual filter grid in a place where they can be individually cleaned by a water hose, and then reinstalling and aligning each filter grid back into the filter grid assembly 29 creates significant opportunities for wear and tear on the septum about each filter grid 12 exterior. Replacing a filter grid that has a hole or tear in its septum can be an expensive, messy experience due to DE being able to free-flow into the pool.

What is needed is a tool or tool system that can be used to clean the septum surfaces of the filter grids of a vertical DE filter that is effective, less time consuming, minimizes the possibility of tearing the septum about the filter grids, and helps to minimize the amount of unsightly contaminated DE that is flushed out of the drain hole and is left to coat the ground surfaces about the vertical DE filter during and after the cleaning process.

### SUMMARY

Embodiments of the invention provide a tool and tool system that is used in a process and method for cleaning the septum surfaces of the filter grids of a vertical DE filter without having to remove the filter grid assembly from the filter body of a vertical DE filter. Use of an exemplary tool and/or tool system effectively cleans the septum surfaces of all the filter grids in the filter grid assembly in less than 30 minutes, with little possibility of wearing or tearing the septum about the filter grids all the while catching a majority of and minimizing the amount of unsightly contaminated DE that is flushed out of the drain hole of the vertical DE filter and left to coat ground surfaces about the DE filter during and after the cleaning process.

In one embodiment a pool DE filter cleaning system is provided that comprises cleaning tool. The cleaning tool comprises an elongate tube having an outer surface, a first end, a second end and a length in a longitudinal direction. Attached to the first end of the elongate tube is a hose connector configured for connection to a supply of water under pressure. A spray nozzle is attached to the second end of the elongate tube. The spray nozzle is configured to produce an angular-radial multidirectional spray pattern. The spray nozzle comprises an open end configured to interface with the second end of the elongate tube. There is also an abutting flange about the circumference of the spray nozzle, wherein the abutting flange is configured to abut the second end of the elongate tube such that the outer diameter of the abutting flange coincides with the outer diameter of the elongate tube and a substantially smooth outer surface transition is established between the outer surface of the elongate tube and the outer diameter of the abutting flange. The spray nozzle further comprises a closed end extending longitudinally away from the second end and the abutting flange, the closed end comprises a plurality of fluid exit ports that extend through the closed end, the plurality of fluid exit ports are configured to direct water under pressure in directions that have both a radial component and a longitudinal component away from the second end, the exterior surface of the of the closed end is substantially smooth, but may be rounded, flat, or in an elongated dome shape.

Embodiments of the pool DE filter cleaning system have the cleaning tool configured to have the second end inserted and moved between and against filter elements of a DE filter without asserting substantial abrasive force or physical pressure on the outer surfaces of the DE filter elements.

Embodiments of the pool DE filter cleaning system are configured to have the outer diameter of the elongate tube be substantially constant along the longitudinal length, such that the outer diameter is between about ¾ of an inch+/−about ¼ of an inch.

In additional embodiments the outer surface of the elongate tube is substantially smooth and constructed of a rigid or semi rigid material. The elongate tube may have a longitudinal length of between about 25 and 50 inches. The elongate tube further comprises an outer diameter configured to slide loosely to snuggly between adjacent DE filter elements while installed within a DE pool filter.

In additional embodiments, the hose connector of the cleaning tool comprises a valve adapted to variably allow water under pressure to move from the first end toward the spray nozzle fluid exit ports and exit the spray nozzle in an oscillating spray pattern comprising both radial and longitudinal components away from the second end.

Embodiments of the pool DE filter cleaning system may be configured such that the closed end of the spray nozzle comprises a rounded outer end surface.

Embodiments of the pool DE filter cleaning system can have the plurality of fluid exit ports on the spray nozzle comprise at least one peripheral lumen angled outward from an axis of the elongate tube at angles between about 0 and 80 degrees.

In additional embodiments of the pool DE filter cleaning system there is included a discharge tube having a connection end and a discharge end, the connection end being configured to establish a watertight interface with a DE pool filter drain port. Along with the discharge tube, the DE filter cleaning system can also include a filter bag comprising an enclosure formed of water permeable material having an inlet opening adapted to be removably attached to the discharge end of the discharge tube, the enclosure adapted to receive and filter DE and debris contained in a discharge fluid exiting the discharge end when the cleaning tool is emitting water from the spray nozzle while the second end is inserted between filter elements of a DE pool filter.

In some embodiments the water permeable material is a mesh-type material. In additional embodiments, the water permeable material comprises flexible material.

Some embodiments have a removable clamp adapted to removably attach the inlet opening about the discharge end of the discharge tube. In other embodiments a tie, drawstring, or hook and loop strap is wrapped about the inlet opening such that the inlet opening is removably fitted to the discharge end.

In yet another embodiment, a DE pool filter drain discharge system is provided that comprises a discharge tube having a connection end and a discharge end, the connection end being adapted to establish a fluid flow interface with a DE pool filter drain port. There may also be included therewith a filter bag comprising an enclosure formed of flexible water permeable material having an inlet opening adapted to be removably attached to the discharge end such that DE and debris contained in a discharge fluid exiting the discharge end are contained in the filter bag when DE filter elements within the DE pool filter are being cleaned.

A DE pool filter drain discharge system can also comprise a discharge tube having a raised portion about the outer circumference of the discharge tube near the discharge end such that the raised portion is adapted to aid with restraining the inlet opening of the filter bag from slipping off the discharge end when the inlet opening is removably attached to the discharge end of the discharge tube. In addition, embodiments can include a means for removably attaching the inlet opening of the filter bag to the discharge end.

In various embodiments of the invention the spray nozzle further comprises a water oscillation chamber between the open end and the closed end. The water oscillation chamber is configured to produce an oscillating water flow having a sonic oscillation frequency.

In yet another embodiment of the inventions, a DE filter cleaning system is provided that comprises an elongate tube having a first end, a second end and length in a longitudinal direction; a hose connector configured to connect to a supply of water under pressure, the hose connector being attached to the first end of the elongate tube; a spray nozzle at the second end of the elongate tube such that an outer surface of the spray nozzle and the elongate tube establish a substantially smooth continuous outer surface. The spray nozzle of an exemplary DE filter cleaning system comprises at least one water oscillation chamber configured to oscillate fluid flow through the spray nozzle such that fluid output from a spray nozzle fluid output is oscillated at a continuous sonic frequency and in a direction that has both a radial component and a longitudinal component away from an axis of the second end.

### BRIEF DESCRIPTION OF THE DRAWINGS

For a more complete understanding, reference is now made to the following description taken in conjunction with the accompanying Drawings in which:

FIG. 1A illustrates a cartridge DE filter;

FIG. 1B illustrates a vertical grid DE filter;

FIG. 1C illustrates an exploded diagram of a DE vertical grid filter;

FIG. 2A illustrates an embodiment of a DE grid filter cleaning tool;

FIG. 2B illustrates an embodiment of the nozzle end of an exemplary DE filter cleaning tool;

FIG. 2C is a front view of the nozzle end of an exemplary DE filter cleaning tool;

FIG. 3A illustrates an exemplary nozzle end cap;

FIG. 3B illustrates an exemplary dome ended nozzle end cap;

FIG. 4A illustrates an exemplary first side cutaway view of an exemplary water pulser or oscillator installed within an exemplary nozzle end cap;

FIG. 4B illustrates an exemplary second side cutaway view of an exemplary water pulser or oscillator installed within an exemplary nozzle end cap;

FIG. 5 depicts another embodiment of an exemplary DE grid filter cleaning tool;

FIG. 6 illustrates a DE filter discharge tube in accordance with an embodiment of the invention;

FIG. 7 illustrates an exemplary discharge tube DE capture bag in accordance with an embodiment of the invention;

FIG. 8 illustrates exemplary discharge tube DE capture bag in accordance with an embodiment of the invention;

FIG. 9 depicts a method of using an exemplary DE grid filter cleaning tool and DE discharge trapping system in accordance with an embodiment of the invention.

FIGS. 10A-10D is a multiview drawing of a quad output fluid oscillation spray nozzle;

FIGS. 11A-11E is a multiview drawing of an oscillator chamber side of a spray nozzle;

FIGS. 12A-12C is a multiview drawing of a center piece of an spray nozzle; and

FIGS. 13A and 13B provide a three-dimensional view and three-dimensional cutaway view of a DE transfer tube.

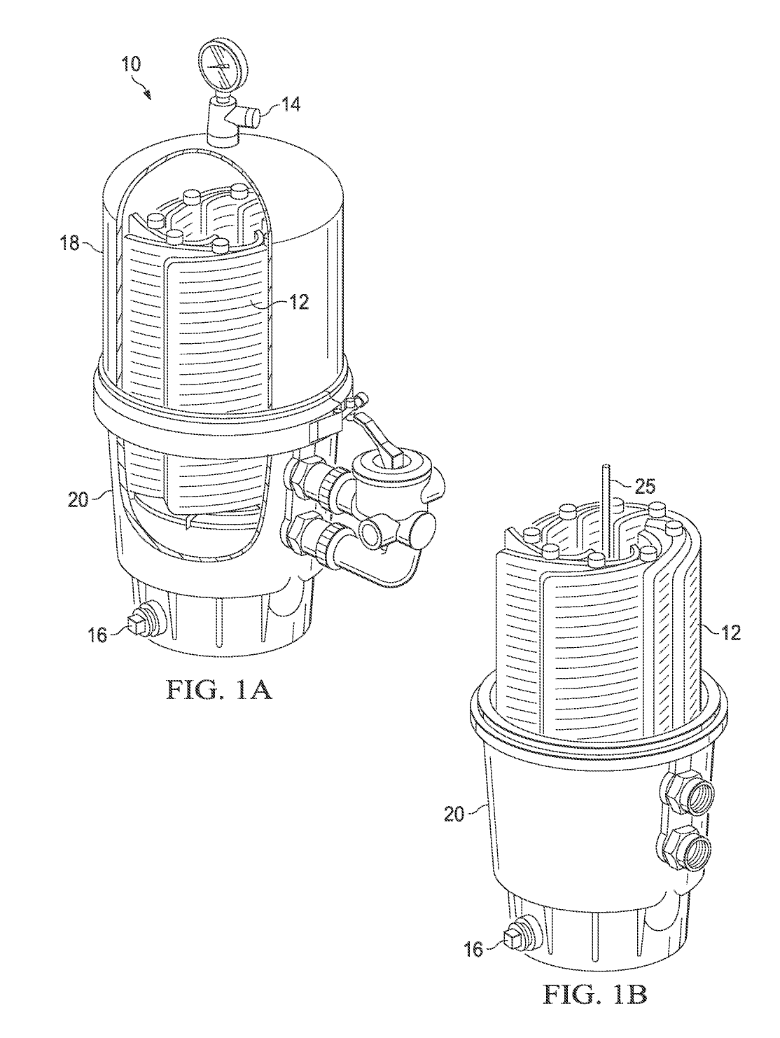

Additional figures on figure pages 1/23 through 23/23 provide additional embodiments.

Similar reference characters denote corresponding features consistently throughout the attached drawings.

### DETAILED DESCRIPTION

Before any embodiments of the invention are explained in detail, it is to be understood that embodiments are not limited in is application to the details of construction and the arrangement of components set forth in the following description or illustrated in the drawing. The invention is capable of other embodiments and of being practiced or of being carried out in various ways. Also, it is to be understood that the phraseology and terminology used herein is for the purpose of description and should not be regarded as limiting. The use of “including”, “comprising”, or “having” and variations thereof herein are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings. Further, “connected” and “coupled” are not restricted to physical or mechanical connections or couplings.

Embodiments of the invention provide a tool and cleaning kit that is configured to clean contaminated DE and other sediment from the septum surfaces of filter grids or cartridges installed within a variety of DE style pool water filtration systems such as cartridge DE pool filters and vertical grid DE pool filters. Embodiments of the invention aid the removal and cleaning the septum surfaces of DE filter grids without requiring that the filter grids, filter grid assembly, or filter cartridge assembly be removed and/or disassembled from within the bottom portion of a DE filter body.

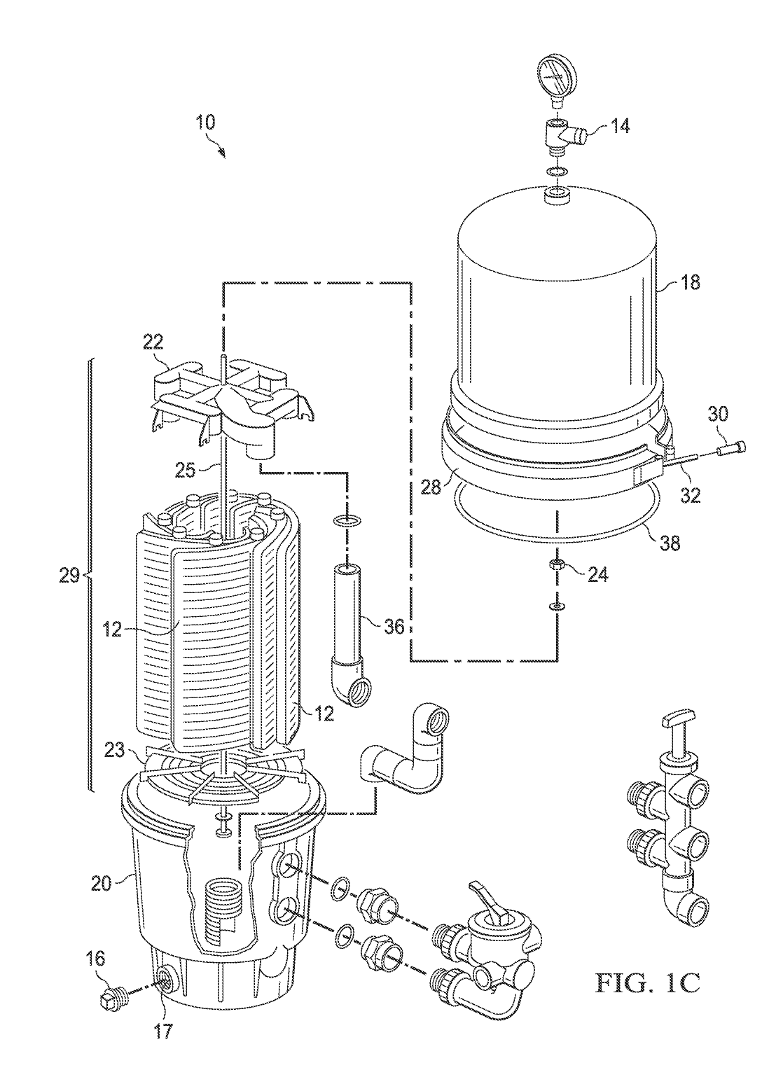

Referring to FIG. 2A, a first embodiment of a DE pool filter cleaning tool 200 is depicted. The DE pool filter cleaning tool 200 has a hose connection end 202 comprising a threaded connection 203 adapted to connect to, for example, a water hose adapted for carrying water or pool filter cleaning fluid. The hose connection end 202 may include a valve device 204 that is ball style, slide style, spring loaded, screw style, stepped style or other type of valve configuration used to control fluid flow. The valve body 205 is used by a user to adjust the water flow or water pressure that can flow from the hose connection end 202 into the tubular extension 206. There are various well known ways of connecting a garden hose to a valve body that can be incorporated into embodiments of the invention that are not discussed herein.

A tubular extension 206 is connected or removably attached to the valve body 205. The tubular extension 206 may be compression fitted, soldered, attached by means of a screw-on attachment, or by other fixed or removable attachment means proximate to the valve body 204. The tubular extension 206 has a longitudinal length 208 of between about 24 to about 60 inches with an outer diameter or cross-sectional width 210 of about ¾ of an inch+/−about ½ inch. Importantly, the outer diameter of the tubular extension is dimensioned to slide between two filter grid elements while installed as part of a filter grid assembly of a DE pool filter. The outer diameter or cross-sectional width 210 may be uniform for the full length of the tubular extension or it may vary or narrow slightly over longitudinal length. In some embodiments the tubular extension is somewhat flexible so that it can bow or flex over its length. The tubular extension may be made of an extruded metal, plastic or polymer, PVC or other reasonable facsimile or derivation thereof. The tubular extension 206, in some embodiments, may comprise goose-neck or accordion-style or flexi-rigid portions to enable user created and changeable bends in the tubular extension length. The tubular extension is hollow over its longitudinal length so that water or other DE filter cleaning fluid or liquid can flow from a first end 212 to a second end 214.

At the second end 214 of the tubular extension 206 is an end cap 216. The end cap 216 may be screwed onto or pressure fit into the second end 214 to establish a water tight seal there between. The end cap may also be glued, soldered, heat welded, crimped or ultrasonic welded into position. The outer diameter or cross-sectional width of the end cap 216 fits within an inner diameter of the second end 214 of the tubular extension 206, except that an end cap flange 218 creates a near smooth or substantially smooth surface interface between the outer surface of the tubular extension 206 and the outer diameter of the flange surface 218 of the end cap 216.

The front side 220 of the end cap 216 comprises a plurality of hollow passages 222 extending from the front side of the front surface 220 to the inside of the end cap 216. The hollow passages 222, which may be organized in an array or pattern, allow water to travel from the interior of the tubular extension 206 to the exterior of the end cap front side 220. In this embodiment, the front side 220 is a substantially smooth flat surface with edges that are rounded as they become the side or flange surface 218.

Referring to FIG. 2B, an alternate end cap 226 embodiment is depicted. The alternate end cap 226 comprises a domed or rounded exterior surface. Hollow passages 228 extend from an inner surface to the exterior surface of the domed or rounded top end cap 226. Hollow passages 228 are adapted to allow water to travel from the interior of the tubular extension 206 through the end cap 226 and out of the rounded exterior surface of the rounded end cap 226. FIG. 2C depicts a front surface or top view of the domed or rounded end cap 226 showing an exemplary array of hollow passages 228. In some embodiments, a center hollow passage 230 is provided. The central hollow passage 230 is surrounded by an array of peripheral hollow passages 232, which are adapted to spray water in somewhat or substantially radial directions about a central axis 234 of the end cap 226 or 216.

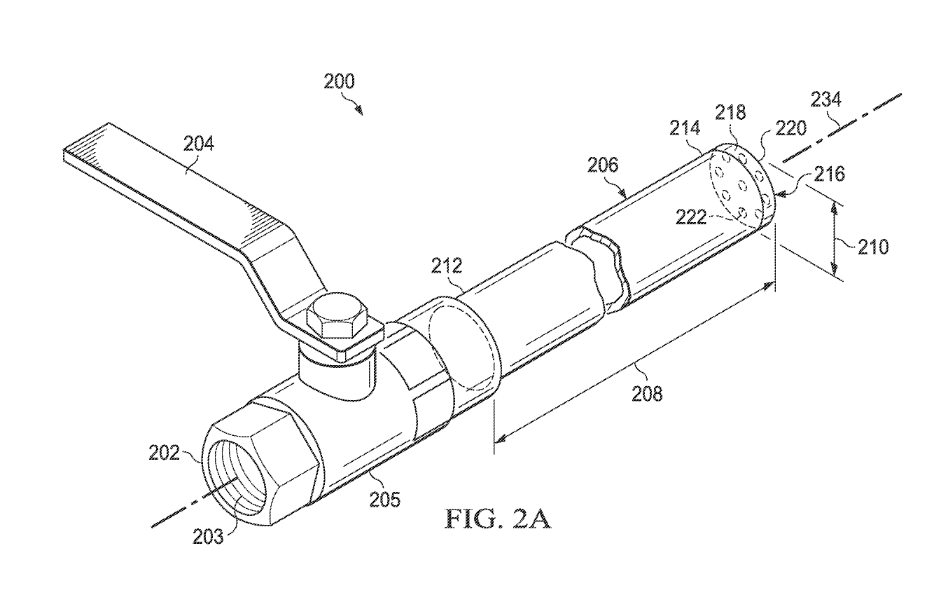

Referring now to FIGS. 3A and 3B, side cutaway views of a variation of the flat top end cap 216 and rounded top end cap 226 are shown. In FIG. 3A, the cutaway view of the flat top end cap 216, depicts exemplary hollow water passages 222 as being angled outwardly from the central axis 300 of the flat top end cap 216. A central or middle water passage 302 extends substantially parallel with or coexists on the central axis 300. The water passages 222 positioned peripherally about the central axis 300 are angled outwardly from the central axis 300 at angles 304 ranging from about 10 to 75 degrees so as to produce a radially forward spread spray pattern when water is forced through the hollow water passages 222. The angled water passages 222 originate on the inside front surface 306 proximate to the central axis 300 and spread outwardly away from the central axis 300.

A cylindrical portion 308 of the end cap 216 extends from the backside of the end portion 310 and flange 218 of the end cap 216. The cylindrical portion is substantially centered about the central axis 300 and comprises and inner wall 312 about a hollow portion to allow water to flow from the tubular extension 206 (FIGS. 2A and 2B) toward the water passages 222 and 302.

The exterior of the cylindrical portion 308 may comprise one or more circumferential bumps, barbs, or ridges. Furthermore, a barbed end 318 may be circumferentially positioned about the entrance of the cylindrical portion 308. The circumferential barbed end 318, in combination with the circumferential ridge 316, aid the end cap (216, 226) in being compression fit into the second end 214 of the tubular extension 206. In some embodiments, an epoxy or silicone sealant may be applied to the outer surface of the cylindrical portion 308 to help hold the end cap 216 inside the second end 214 of the tubular extension 206, as well as help to create a near watertight seal between the outer surface of the cylindrical portion 308 and an inner surface of the tubular extension.

In some embodiments partial barrier 317 having an annular opening 319 in the center is spaced about a distance from inside front surface 306. The annular opening 319 having a larger diameter than the central water passage 302 so as to produce a circular oscillation of fluid flow 321, which ultimately produces a sonic pulsed fluid flow through the central (and/or angled) water passages. The distance D may be the same as the inner diameter of the end cap.

Referring to FIG. 3B, a side cutaway view of the domed end cap 226 is depicted. Exemplary hollow water passages 320 are angled or vectored radially outwardly from the central axis 322 of the dome-top end cap 226. In some embodiments, a central hollow water passage 324 extends from the interior of the domed end cap to the top or front surface of the domed end cap, along the central axis 322. On the interior side of the domed portion of the end cap, the interior wall may be a domed interior wall 326.

In other embodiments, the interior wall 327 may be depicted by the dotted line 328 and have a cone cutout 329 (or in some embodiments a concave form) such that the hollow water passages 320 and 324 all extend to a central area about the central axis 322, along the inner cone cutout portion 329 (or inner concave portion). This design helps unify the spray pressure on each hollow water passage. The cylindrical portion 330 may be substantially similar to the cylindrical portion 308 as described with FIG. 3A. Additional embodiments may have partial barrier 317 spaced a distance D from the interior wall 327, wherein D is similar to the inner diameter of the D of the end cap 226.

In additional embodiments, the end cap portions 216 or 226 may have cylindrical portions 308,330 that screw into the second end 214 of the tubular extension 206. In using a screw-on type end cap, a polymer or a rubber washer may be used between the contact flange surfaces 332, 334, of the end caps 226, 216, respectively, to create a watertight seal against the end surface 336 of the second end 214.

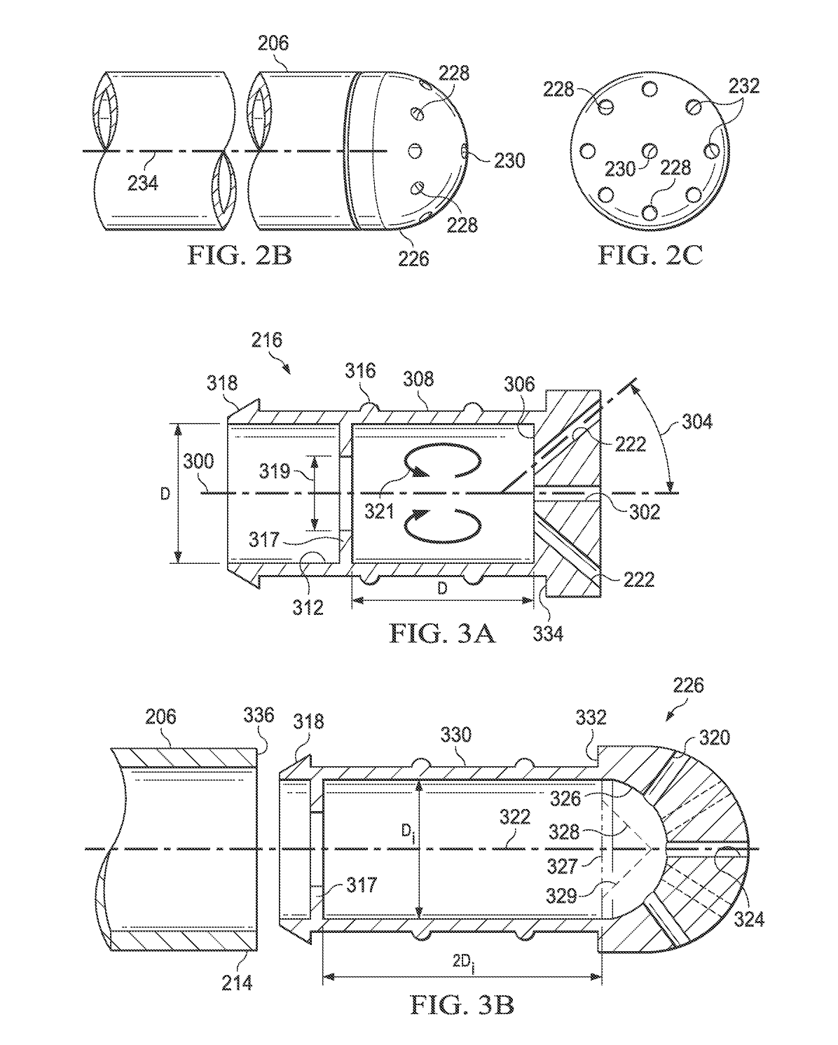

Referring now to FIGS. 4a and 4b, side cutaway views of a flat-top end cap 400 are shown rotated 90 degrees about the longitudinal axis 402 with respect to each other. A means for modulating the water flow is positioned within the exemplary end cap 400. The end cap 400 is shown to be installed within the second end of the tubular extension 206. In this embodiment, the modulating means comprises a spinner 404 having a width, w, and a length, l, that are each 2 to 10 percent shorter than the inner diameter, d, of the cylindrical portion 406 of the end cap 400.

The side view of the spinner portion 404, seen in FIG. 4a, shows that the spinner portion 404 has an S shape centered on an axle end 408. There are two axle ends on either side of the spinner 404, as can be seen in FIG. 4b. The axle ends 408 may be axial posts that snap-fit into an axle-receiving notch or space 410 positioned on opposing sides of the inner wall of the cylindrical portion 406. As water flow, which is indicated by the arrows 412, moves toward the end cap 400 via the inside of the cylindrical portion 406 from the tubular extension 206, the spinner 404 spins about its axis 414, which coincides with the axle ends 408. The spinning action of the spinner modulates the pressure of the water flow 412 just before the water flow reaches the hollow water passages 418. The spinning action of the spinner creates a pulsation or modulation of the water flow as it is being forced through the hollow water passages 418. The pulsating or oscillating water flow force has been shown to enhance removal of contaminated DE and other sediment from the septum surfaces of filter grids or cartridges installed within a variety of DE-style pool water filtration systems. Embodiments may modulate or pulse the water flow through the water passages at frequencies ranging from about 5 Hz to about 1000 Hz. The pulsed modulated or oscillating water flow is created proximate to the septum surfaces of the DE filter grids. In some embodiments the modulator means is of other configurations that may or may not have moving parts such as a fluid oscillator configured to pulse fluid flow in order to enhance removal of DE from a filter grid surface proximate to the end cap fluid output(s). Furthermore, the modulation means or device may be positioned substantially anywhere within the tubular extension or the hose connection end.

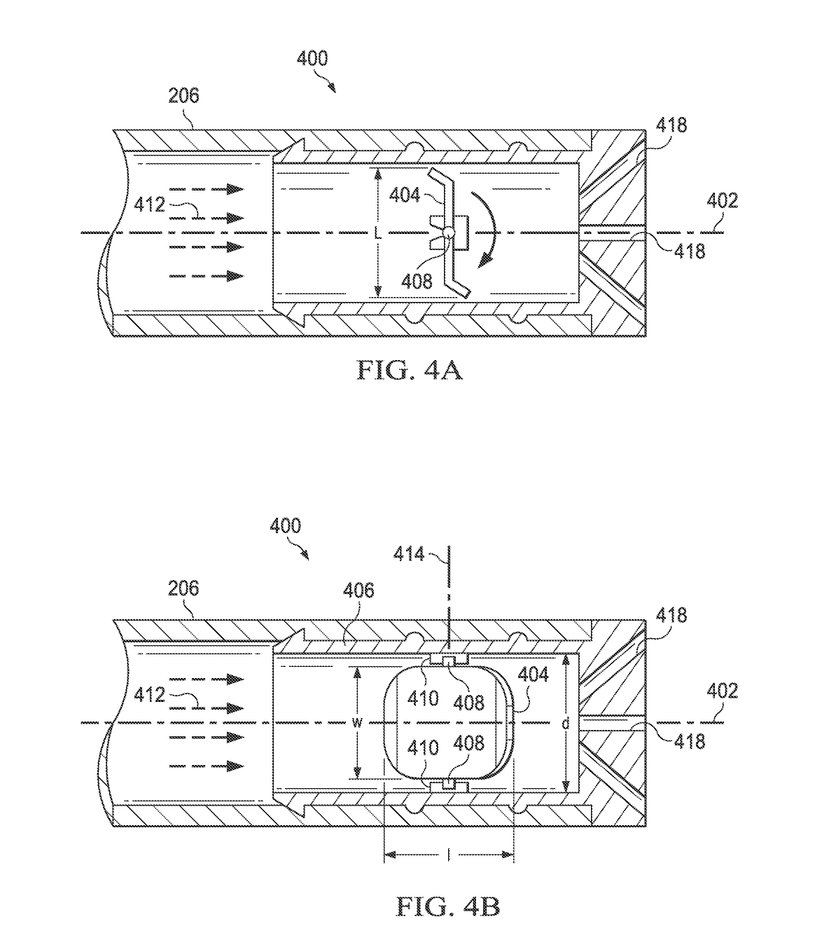

Referring to FIG. 5, a trigger-operated DE filter septum cleaning device 500 is depicted. Here a nozzle body 502, comprising a head portion 506 and a neck portion 504, has a garden hose connection 508 positioned at an input end of the neck portion 504. The garden hose connection 508 allows a hose, such as a garden hose, to connect or be removably attached to the hose connection 508. A squeeze handle 512 attaches to a pivot 514 positioned on the neck portion 504. When the squeeze handle is squeezed toward the neck portion 504, the pullback portion 516 of the squeeze handle pulls the plunger body 518 back in the direction of arrows 520. When the plunger body 518 is pulled back, the valve plunger 522 is pulled back from the exit orifice 524, thereby allowing water flow and pressure from the hose 510 through the nozzle body into the tubular extension 530.

The tubular extension 530 has a proximate end 532 and a distal end 534. The proximate end 532 may be permanently attached or removably attached to the nozzle opened end 536 of the nozzle body 502. The proximate end 532 of the tubular extension 530 may have a connection end that is pressure fit screwed onto or attached in another know way to the nozzle opened end 536. The connection end 540 may comprise external threading so as to screw into some internal threading on the inside of the nozzle opened end 536. In alternate embodiments, the connection end 540 may be on the exterior of the nozzle opened end 536 such that the connection end 540 has threading on its interior and the nozzle opened end 536 has threading on its exterior so as to attach the nozzle body 502 to the tubular extension 530.

It is understood that there are a plurality of designs for nozzle bodies that perform substantially the same function to provide substantially the same result as the nozzle body 502 depicted herein. Thus, embodiments of the invention may comprise a variety of different types of nozzle bodies that can be permanently or removably connected to an exemplary tubular extension 530 at the connection end 540 by a variety of connection means. Such connection means at the connection end 540 of a tubular extension 530 may include, but not be limited to, a compression fit, snap fit, screw-on fit, ultrasonic or heat welded, crimp, notched fit, or any type of adhesive connection.

The tubular extension may extend from the proximate end 532 for about 16 to about 60 inches. The tubular extension 530 comprises a hollow inner portion 542 for water flow to pass from the proximate end 532 to the distal end 534. The tubular extension 530 may be constructed of a rigid, semi-rigid, or somewhat flexible tubing having an outer diameter of between one-half inches to about one inch. The outer surface of the tubular extension is generally smooth but may be circular, octagonal, or have multiple-faceted sides. The outer diameter of the tubular extension is configured to fit between the vertical grids of a DE pool filter.

In some embodiments, a ball valve 544 may be positioned within the tubular extension 530. The ball valve 544 may have a ball valve handle 546 that enables a user to turn or rotate the ball valve into an open or closed position, thereby controlling water flow through the tubular extension 530 from an off position to a controlled on position and then to an all-the-way-open on position. The ball valve/ball valve handle (544, 546) enables a user to set a maximum flow rate through the tubular extension toward the distal end 534.

At the distal end 534, an end cap 550 is shown to be attached to the distal end 534 of the tubular extension. The end cap 550 may be permanently or removably attachable to the distal end 534. The end cap 550 may be attached by a variety of means including, without limitation: pressure fit, glue, ultrasonic welding, heat welding, screw-in connection, crimp, clip or clamp-in connection, overlapping or under lapping connection, or other permanent or removable connection techniques known in the art.

It is important that the outer surface 552 of the end cap is flush or smooth where it meets with the outer surface of the tubular extension 554 at the joining or outer interface position 556. Furthermore, the end cap should be no more than a quarter inch in cross-width or outer diameter larger than the cross-width or outer diameter of the tubular extension 530. The end cap 550 may be constructed of a variety of metals or metal alloys as well as plastics, PVC, ceramic, epoxy or other polymer-type materials. The end cap 550 shown has a domed or rounded outer surface 552 and one central or a plurality of hollow water passages extending from an interior side 558 of the end cap 550 to and through the outer surface 552 of the end cap. The hollow passages 560 generally extend from a central portion of the interior side 558 of the end cap 550 radially or somewhat radially outward toward the outer surface 552 of the end cap 550. Dashed lines 562 indicate the sonic pulsed radial-forward direction of the water flow exiting the hollow passages 560.

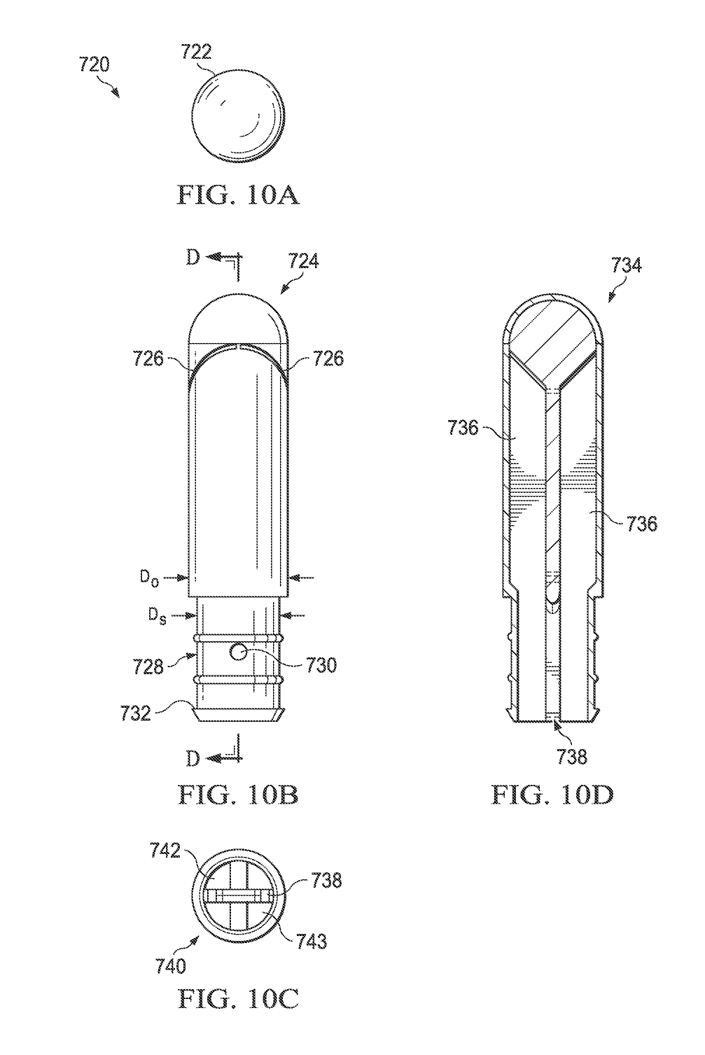

In additional embodiments, an oscillator or pulsator device 566 may be installed within the end cap 550. The depicted oscillator or pulsator device 566 rotates on an axis 568 as water (not specifically shown) flows toward the distal end 534 and out the hollow passage or passages 560. The pulsator or oscillator device 566 actively pulses the water flow through the interior portion of the end cap 550, thereby oscillating, or pulsating the water as it exits the hollow passages 560. The oscillating and/or pulsating of water is shown via the dashed lines 562, representing sonic pulsating water exiting the hollow passages 560. Various water pulsating designs can be utilized to modulate the water streams exiting the end cap 550. In additional embodiments fluid oscillators having no moving parts can be used to produce pulsed, modulated or oscillated water at an output port of an end cap nozzle. Furthermore, single-stage, multi-stage, feed-back, non-feedback, and parallel fluid oscillators some of which are depicted in FIGS. 10, 11 and 12 are also well suited for providing pulsing or oscillating water flow at the output port(s) of an exemplary nozzle device so as to improve the ability an exemplary device to clean grit, grim, slim and dirty DE from the filter grids of a DE filter when in very close proximity to the outer surface of a DE filter grid.

The smooth joining of the outer surfaces 556 of the outer surface of the end cap 552 and outer surface of the tubular extension 554 is important in embodiments of the invention so that when the end cap and tubular extension is moved up and down and/or around between the filter grid elements within a DE filter, there is minimal abrasive, scratching, or tearing of the septum material covering the outside of each filter element. Furthermore, it has been found that the pulsing of water flow out of an exemplary end cap aids in the removal of contaminated or dirty DE material lodged on the septum of a filter grid panel or cartridge. Further, the radial or radially forward direction of the hollow passages 560 allow for an exemplary DE filter septum cleaning device to have its end cap positioned between filtration panels, yet spray at or toward the filter panels, as well as push the removed contaminated DE material from the septum of the filter panels in a similar direction or generally downward direction, as will be explained below.

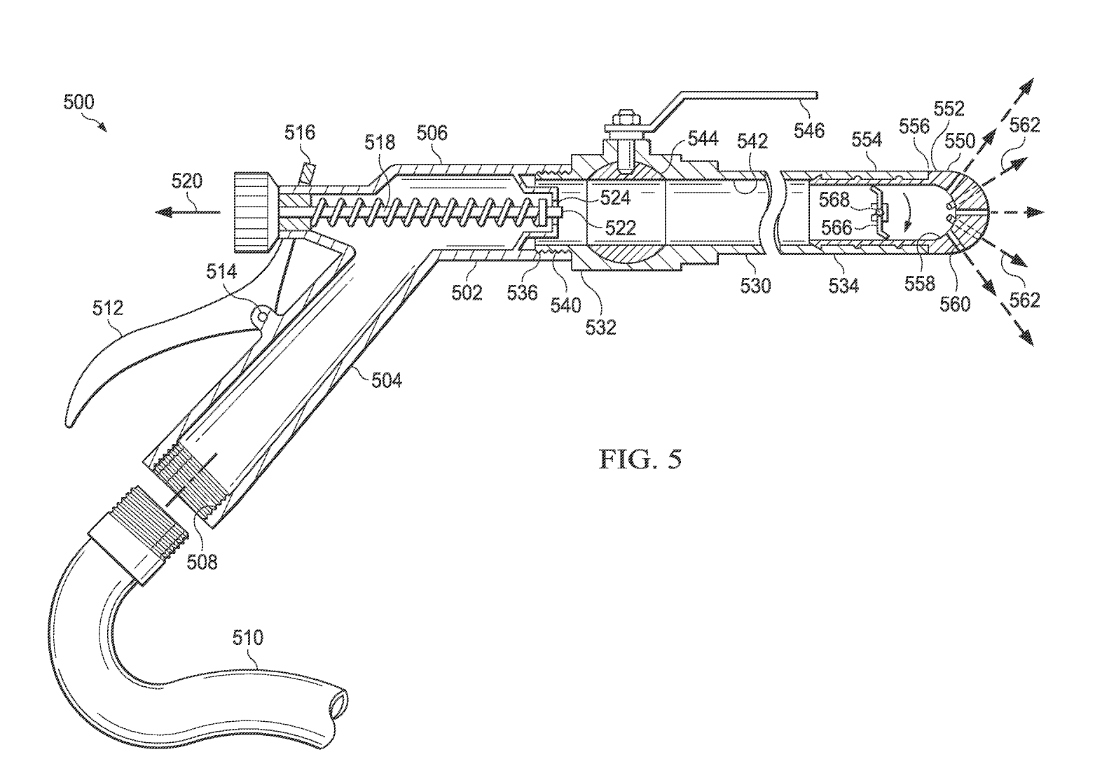

Referring now to FIGS. 6, 7, and 8, an exemplary contaminated DE capture apparatus is depicted. An exemplary contaminated DE capture apparatus can be provided as part of a kit that includes a DE pool filter cleaning tool as both devices can be advantageously used together. A DE filter drain extension 600 can be screwed into or attached to the drain plug exit 16 near the bottom of a DE filter body via the screw attachment 602, provided at a first end of the DE filter drain extension 600. The DE filter drain extension 600 may further comprise a ball valve 604 attached to a ball valve handle 606 that may be opened and closed during a cleaning process of the DE filter grids within a DE filter by an exemplary DE filter cleaning tool. At a second end of the DE filter drain extension, which may be a hollow or cylindrical PVC pipe, plastic tube, or metal fitting, are exemplary means for attaching a bag or collection device adapted to collect contaminated DE that exits the drain hole of a DE grid or DE cartridge filter base.

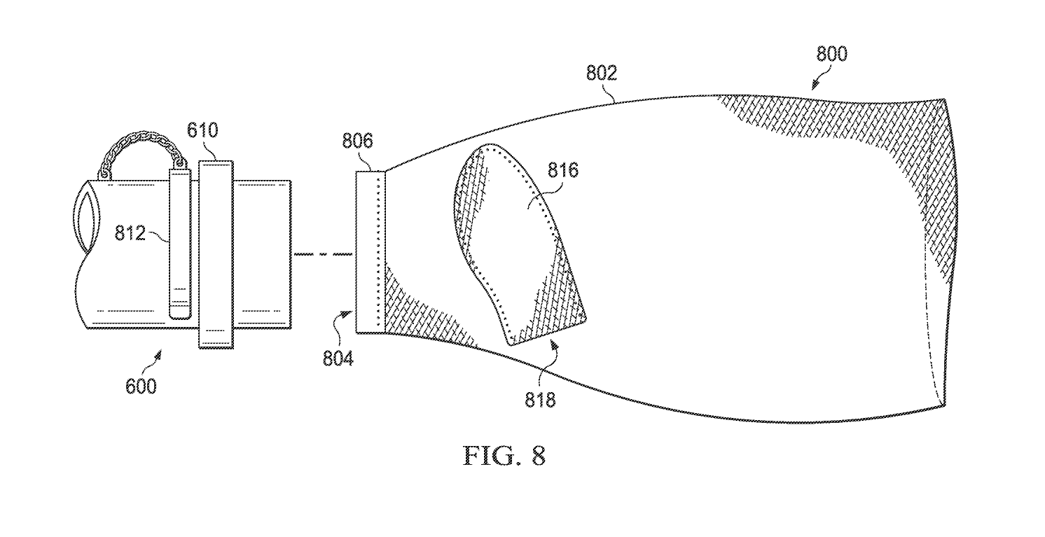

In some embodiments, a bag stop 610 that protrudes from the outer surface of the DE water drain extension tube 612 and may be circumferentially formed about the DE water drain extension tube 612. The DE bag stop flange 610 may protrude from ¼ to ¾ of an inch beyond and about the outer diameter of the DE water drain extension tube 612. Referring to FIG. 8, an exemplary contaminated DE collection bag 800 is depicted. The collection bag 800 may be comprised of a porous or mesh material configured to allow water flow therethrough, but further adapted to have a porosity small enough to inhibit a majority of any contaminated DE or debris from flowing therethrough. An exemplary collection bag may have an inner volume of from about two gallons to about 15 gallons of available volume.

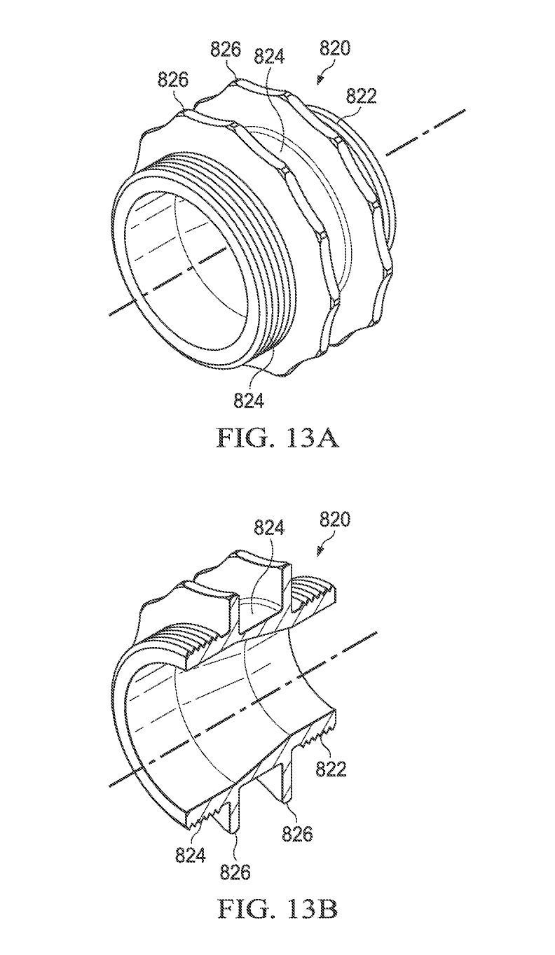

Another embodiment of a DE filter drain extension or DE transfer tube is depicted in FIGS. 13A and 13B.

The collection bag or strainer bag 800 has have an opening 804 adapted for entry of contaminated DE. The opening 804 may comprise an elastic collar or draw string about or proximate to the end of the opening 804. The elastic collar or opening is adapted to stretch about the bag stop 610. Upon stretching the elastic collar end 806 about the bag stop 810, a collar clip 812 may be placed over and substantially about and proximate to the elastic collar end 806 so as to inhibit the opening 804 from being pulled past the bag stop 810 and being disconnected from the DE filter drain extension 600. The collar clip 812 may be made of a spring metal or flexible plastic material so as to be able to clip and/or clamp about the circumference of the DE water drain extension tube 812 at a location proximate to the bag stop 610. In some embodiments, a collar clip chain or string may be attached from a position on the DE filter drain extension 600 and connect to the collar clip 812 so as to help inhibit loss or displacement of the collar clip 812. Other techniques of attaching the opening 804 to the second end of the DE filter drain extension can be used such as wrapping double sided hook and loop material about the opening or using a clip connection or tie to go about the bag opening.

Still referring to FIG. 8, the collection bag 800 may comprise a flap insert 816 which may be sewn or attached in a straight or angular circumferential position about the interior of the collection bag 800. The flap insert 816 should further be located in the first quarter or third of the collection bag 800 closest to the opening 804. The flap insert 816 has an opening portion wherein it is not sewn about the inner periphery of the collection bag 800. The flap opening 818 allows water and contaminated DE to flow therethrough, but helps to inhibit a backflow of contaminated DE when an exemplary collection bag 800 is removed from the second end or bag stop portion 610 of the DE filter drain extension 600.

Referring again to FIG. 6, embodiments of the invention may further comprise a bag attach locking means 620. The bag attach locking means 620 is adapted to enable a collar 702 of a second exemplary collection bag 700 to be locked into place via a locking peg 704 and a twisting motion. The collar 702 may be rigid or semi-rigid such that the locking peg fits into the twist locking means 620 and locks therein at the locking location 621. Although not specifically shown, two or more locking means 620 and locking pegs 704 may be located about the locking collar 702.

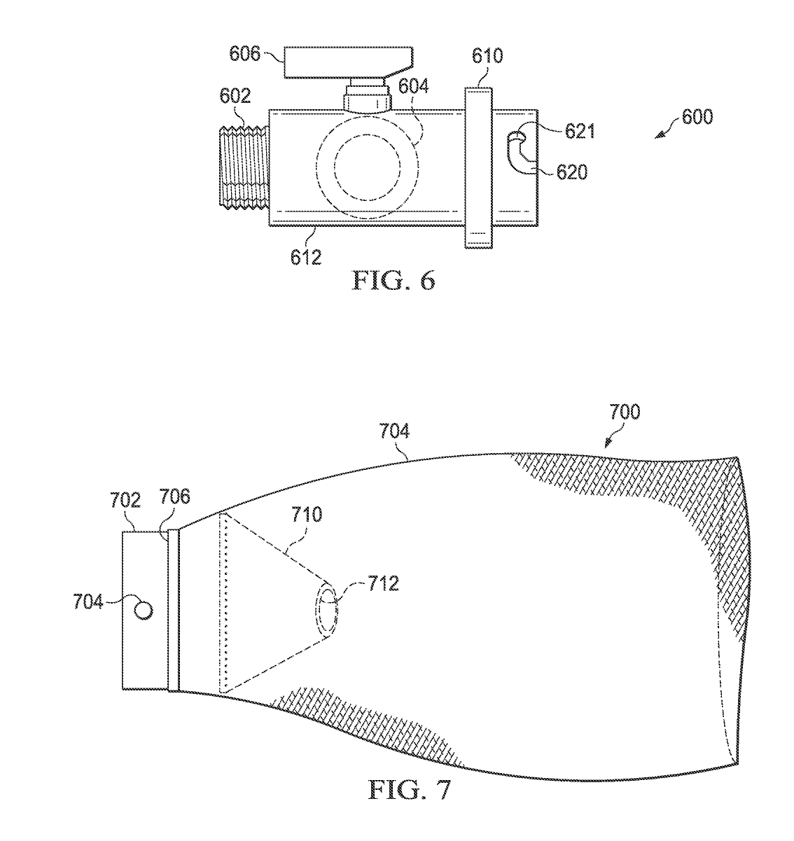

Referring to FIG. 7, the second exemplary collection bag 700 may also be made of a porous plastic or woven mesh fabric having a porosity adapted to allow water to flow therethrough, yet inhibit a majority of DE or contaminated DE from flowing therethrough, as is known by one of ordinary skill in the art. The porous mesh bag 704 may be foldable or collapsible. Furthermore, the porous mesh bag 704 will have an opening 706 attached to the collar 702. The opening 706 of the mesh bag may be attached to the collar 702 via plastic crimp, heat weld, folded crimp, ultrasonic weld, glue or other adhesive, pull string, string tie or an exterior fitted ring holding the opening 706 in place against the collar 702.

Within the second exemplary collection bag 700 may be a cone insert 710. The wide portion of the cone insert may be sewn or attached by other means about an inner circumference or inner walls of the mesh bag 704. The cone insert should be attached proximate to or within a few inches of the opening 706 of the porous mesh bag 704. The cone insert may be made of the same porous mesh or plastic material as the exterior of the exemplary collection bag 700, or may be made of a nonporous or less porous material.

The cone opening 712, being located at a narrow end of the cone insert 710, allows water and contaminated DE to flow into the interior of the second exemplary bag 700 wherein the water may exit the collection bag 700 via the porous mesh material 704 and the majority of the contaminated DE is contained within the collection bag 700. The cone insert 710 is adapted to help prevent some backflow of the water and/or contaminated DE during the cleaning process of a DE grid or DE cartridge filter, in accordance with the teachings of the exemplary embodiments of the invention. When either collection bag 700 or collection bag 800 are full or when the cleaning process of a DE filter is completed, each bag may be removably detached from the locking means 620 or bag stop 610/collar clip 812 so as to allow disposal of the collected contaminated DE and/or disposal of the entire collection bag and its contents.

Referring to FIG. 6, the ball valve 604 and valve handle 606 can be used to adjust a flow of contaminated DE or water from a DE filter that is being cleaned to an exemplary collection bag (700, 800). The ball valve 604 and valve handle 606 can be very useful in helping to minimize the amount of contaminated DE that is spread or that flows onto the ground about a DE filter that is being back flushed and cleaned in accordance with embodiments of the invention.

As will be better understood below, an exemplary cleaning tool and DE capture apparatus may be provided together as a DE filter cleaning kit.

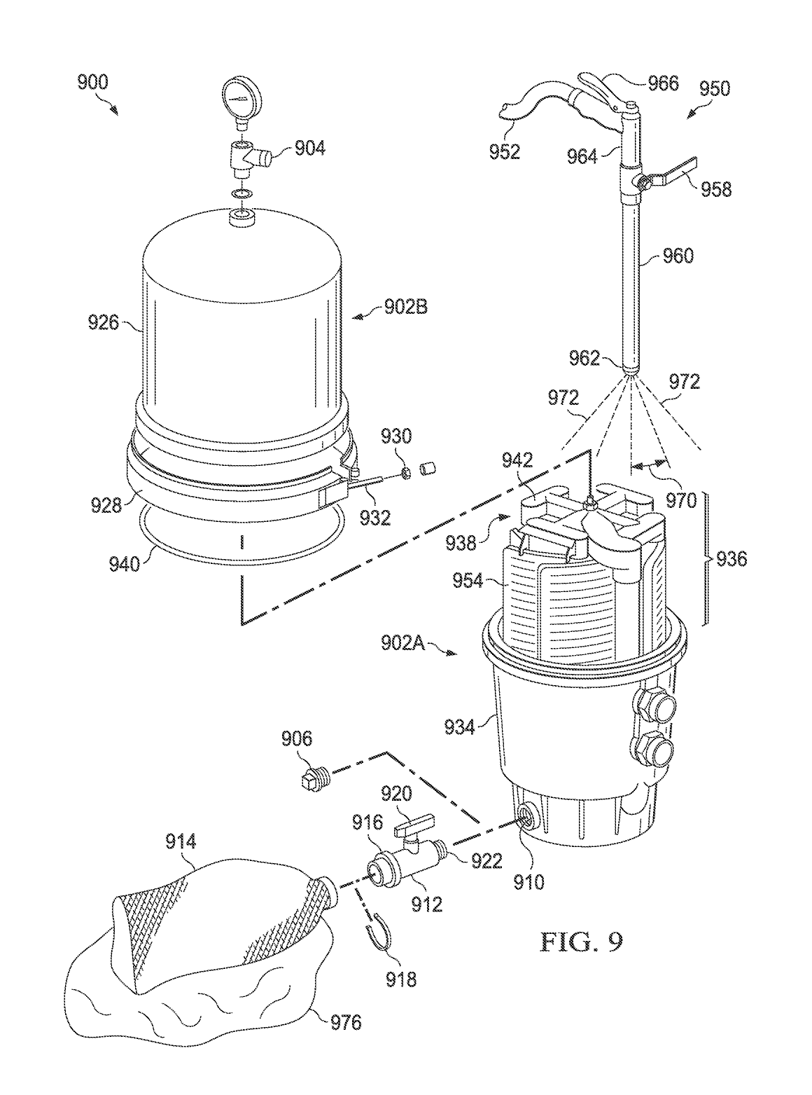

Referring now to FIG. 9, an exemplary system and method 900 for cleaning a vertical DE filter is shown and depicted via a partial exploded view. First, assuming that the vertical DE filter (902A, 902B) is in need of cleaning, a user may in some methods, in accordance with the invention, first back flush the DE filter (902A, 902B) in accordance with normal back flush procedures provided by the DE filter manufacturer. In yet other embodiments of the exemplary methods of the invention, an initial back flushing of a DE filter (902A, 902B) is not necessarily required.

After back flushing—or, in some circumstances, without back flushing—the relief valve 904 may be opened so as to allow the water level within the DE filter vessel to become lower. The drain plug 906 may be removed from the drain plug hole 910 by unscrewing it therefrom. At that time, an exemplary DE filter drain extension 912 may be screwed into or connected with the drain plug hole 910, depending on the configuration of the DE filter (902A, B).

An exemplary collection bag 914 may be locked in place, clipped or attached onto the bag stop 916 of the DE filter drain extension 912 via a collar clip 918 hook and loop material or a drawstring. In some embodiments, the ball valve 920 on the DE drain extension 912 may be positioned in a closed position initially. It is understood that some water from within the DE filter (902A, B) may leak out of the drain plug hole 910 while the DE filter drain extension 912 is connected to the drain plug hole 910 via the screw connection 922 or other applicable removable connection means, such as clamps, clips, quarter-turn locking mechanisms, et cetera.

At this time the filter tank lid 926 is removed. In order to remove the filter tank lid 926, the tank clamp assembly 928 is disassembled by loosening the tank clamp nut 930. It should be understood that not every vertical DE filter comprises a tank clamp assembly of this type, but one of ordinary skill in the art using the instructions that come with a DE filter would be able to remove the filter tank lid 926 of substantially any DE filter configuration. After the tank clamp assembly 928 is removed, the filter tank lid 926 may be lifted straight off of the lower filter body 934, revealing an upper portion 936 of the vertical DE filter assembly 938 contained within a DE filter tank (902A, B). A sealing O-ring 940 may also be removed from about the circumference of the interface between the lower filter body 934 and the lower portion of the filter tank lid 926.

Using embodiments of the present invention, there is no need to remove the spreader or manifold 942 and disassemble the vertical DE filter assembly 938. Conversely, embodiments of the invention allow a user to leave the vertical DE filter assembly assembled and inside the lower filter body 934 during an exemplary DE filter cleaning process.

The ball valve 920 on the DE filter drain extension 912 may be moved to an open position at this time. Furthermore, an exemplary DE filter cleaner 950 may be removably attached to a hose 952, the hose being adapted to provide water or other cleaning fluid to be used to clean the DE filter grid elements 954 contained within the vertical filter assembly 938. If so equipped on an exemplary DE filter cleaning tool 950, the ball valve, or other reasonable facsimile or derivation thereof, may be turned to an ON position to allow fluid flow from the hose 952 through the tubular extension 960 and down toward the end cap 962. Further, if an exemplary DE filter cleaning tool 950 is so equipped, the spray nozzle 964 may have its handle 966 squeezed by the user so as to open the valve(s) within the spray nozzle and allow pressurized water or cleaning fluid to travel down the tubular extension 960 toward the end cap 962.

Upon reaching the end cap, the water is forced through one or an array of hollow passages in the end cap (not clearly shown in this figure) so as establish water jets or a cone of spray 972 radially outward and somewhat downward or forward from the end cap 962 and the tubular extension. This is shown with the dashed lines extending from the end cap 962. In various embodiments, the cone or spray of water may comprise a sonic oscillation also depicted by the dashed lines exiting the end cap or spray nozzle 962. Furthermore, a single hollow passage in the end cap tip or center location of the array of hollow passages may spray a stream of water or cleaning fluid in a direction that is substantially longitudinal with the tubular extension. The water jets exiting the hollow passages on the tip of the end cap 960 may spray at an angle between 85 and 15 degrees 970 from the longitudinal axis 972 of the tubular extension 960. It should be understood that the end cap 962 interfaces substantially smoothly with the outer surface of the tubular extension 960 so as to minimize potential scratching or tearing of the filter grid septum surfaces during a DE filter cleaning process.

Within an exemplary DE filter cleaning tool 950, a water modulator device modulates the water flow prior to the water exiting the end cap.

At this time the tubular extension 960 and end cap 962 may be lowered into the vertical DE filter assembly 938 such that it is positioned in between two adjacent DE filter grid elements. With water flowing through the tubular extension and the downward-angled spray of the end cap 962, contaminated DE is easily removed and pushed toward the bottom interior of the lower filter body 934, where it can exit the drain plug hole 910 through the DE filter extension 912 and into an exemplary DE collection or strainer bag 914. In some embodiments the spray nozzle 962 produces sonic oscillating or pulsed water flow that aids in removing contaminated DE from the septum of the DE filter grids more thoroughly and efficiently. The sonic oscillating jets or water flow exiting outputs of the nozzle can be against, or proximate to the filter grid surface.

The collection bag 914 allows the water to exit the mesh or porous outer bag material of the collection bag, forming a water puddle 976 about the collection bag. The contaminated DE is substantially retained within the collection bag 914. Thus a vast majority of the contaminated DE which is being flushed or washed from the DE filter grid elements 954 by the DE filter tool 915 is trapped in the collection bag 914, thereby not creating an unsightly formation of contaminated DE about the DE filter (902A, B) that is being cleaned.

Moving the tubular extension up and down between the plurality of DE filter grid elements 954 within the vertical DE filter assembly 938 enables the user to clean the DE filter grids as well as—and, with some embodiments, better than—disassembling the filter assembly 938 and cleaning each individual DE filter grid element separately and individually prior to being reassembled. Furthermore, by not requiring a disassembly and reassembly of the DE filter grid elements 954, embodiments and methods of the invention create less wear and tear on the individual DE filter grid elements and their septum coverings than if they were removed, handled multiple different ways, and then reassembled, and placed back into the lower filter body 934.

In some embodiments, a oscillation or pulsator device is positioned in or substantially near the end cap 962 of the DE cleaning tool 950. In other embodiments the water flow modulator or pulsator is located further from the end cap. It has been found that pulsating the water flow at a sonic frequency while spraying the septum material on DE filter grid elements decreases the amount of time it takes to clean the DE grid filter elements within a vertical DE filter assembly while the DE filter assembly 938 remains within the lower filter body 934 of a DE filter than if the water flow was in a continuous non-oscillating stream.

Experimentation and testing has shown that a vertical grid DE filter can be cleaned using the method and embodiments of the invention within 10 to 30 minutes from start to finish by a non-professional, untrained pool filter cleaning person. This is a vast improvement over the 45-minute to more than about two to six hours required using previous methods and techniques wherein the entire vertical DE filter assembly is removed from the lower filter body, disassembled, and each vertical DE filter element is individually cleaned separately.

Although not specifically shown, some embodiments further include a cleaning additive that is added to the water prior to or as the water travels through an exemplary DE filtering tool 950. The additive may further enhance suntan lotion removal, oil removal, and other contaminant removal that may be present on the septum coverings of the DE filter grids being cleaned. In other methods, the cleaning additive can be sprayed onto the DE filter assembly prior to the step for inserting the exemplary tool between the filter elements.

In addition, other exemplary methods include using an exemplary DE filter cleaning tool 950 to clean cartridge-style DE filters wherein the exemplary DE filter cleaning tool is moved up and down inside the interior cylindrical area of a cartridge DE filter grid, as well as outside the cylindrical area, as would be understood by one of ordinary skill in the art.

Although illustrated embodiments of the invention have been described, the foregoing description is not intended to limit the scope of the invention. Various modifications and combinations of the invention embodiments, as well as other embodiments of the invention, will be apparent to persons skilled in the art upon reference to the description. It is therefore intended that the appended claims incorporate any such modifications or embodiments.

It will further be appreciated by those skilled in the art having the benefit of this disclosure that this DE pool filter cleaning tool, collection bag system, and method of cleaning a DE filter provides a potential water-saving and faster technique for deep cleaning a vertical grid DE pool filter, while subjecting the septum surfaces of the DE filter grids to minimal wear and tear so that they may last longer and save the pool owner additional money.

FIGS. 10A-10D is a multiview drawing of a quad output fluid oscillation nozzle 720. The top view depicts a rounded top or tip 722 of the nozzle 720. The first side view 724 shows the exterior of the quad output fluid oscillation nozzle 722 having two fluid output vents 726 angularly positioned near the top of the nozzle and near the tip 722. The nozzle 720 has an outer diameter Do that is configured to fit between 2 DE filter grids while they are installed within a DE filter grid assembly. At the bottom of the nozzle 720 is insertion portion 728 having a diameter Ds that is configured to slide or fit within the distal end of the tubular extension shown in previous Figures. The insertion portion 728 may be held firmly or attached within the distal end of the tubular extension via sonic welding, epoxy, crimping or by other methods already mentioned. Additionally, a pop rivet or blind rivet may be inserted in a through hole through the wall of the distal end of the tubular extension and aligned with the hole 730 on the side of the insertion portion 728. A sweeper or wiper portion 732 extends radially outward about the circumference of the insertion portion. The wiper portion 732 is configured to be crushed, bent or flexed toward the top of the nozzle when the insertion portion 728 is inserted into the distal end of the tubular extension. The wiper portion 732 help so center, secure a snuggle fit and aide in sealing the insertion portion against the inside of the distal end of the tubular extension. The second side view 734 shows that this nozzle embodiment 720 comprises three pieces that are fitted together. The three pieces being two substantially identical fluid oscillator chamber sides 736 and a centerpiece 738. As one can easily understand from the multiview of FIG. 10 the three-piece nozzle configuration provides four fluid outputs or vent openings 726. Each of the four fluid outputs 726 are configured such that the oscillating fluid exiting there through will spray in an almost 360° near conical configuration about the nozzle tip.

A bottom view 740 of the nozzle 720 is shown depicting the fluid or water input section. The input portion of the centerpiece is shown to be configured to divide an input fluid flow into two input flow paths 742 and 743, which enter the dual parallel fluid oscillators sections within the nozzle oscillation chambers.

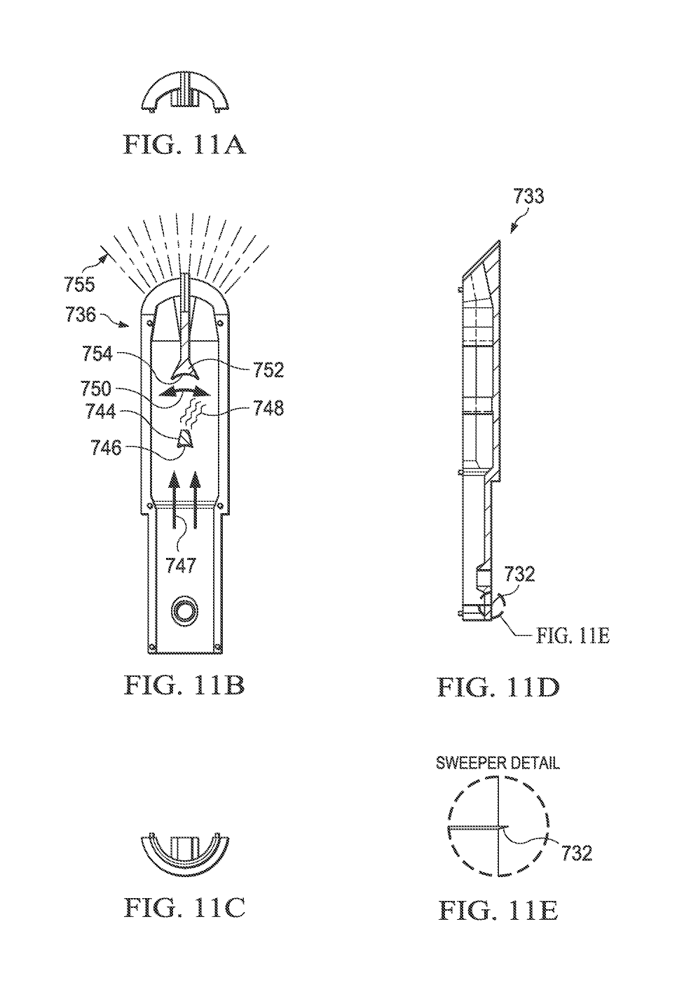

FIGS. 11A-11E is a multiview of an oscillator chamber side 736 and depicts the interior of the oscillator chamber side 736. Here a dual fluid oscillator chamber is shown with the nozzle structure having a first fluid oscillation barrier 744 that is configured to present a concave arc 746 to the fluid flow shown by arrow 747. The first oscillation barrier 744 creates eddy currents that oscillate back-and-forth in accordance with the arrow 750. The eddy current's back and forth oscillations are amplified due to being subjected to the second fluid oscillation barrier 752, which presents a concave arc 754 to the oncoming fluid flow and eddy currents 748. The concave arc 754 is larger (i.e., wider) than the first concave arc 746. In some embodiments the second concave arc 754 is from 1.1 to about 2.5 times wider than the first concave arc 746. The result of the oscillating 750 back and forth eddy currents 748 is the creation of an alternating oscillating fluid output 755, which oscillates or pulses at a sonic frequency. The oscillating fluid output is configured to improve the removal of DE, contaminated DE, and other materials form the septum of a DE filter grid while the nozzle tip 720 is in close proximity to the outer surfaces and between two DE filter grids installed within a DE filter grid assembly 938 as shown in FIG. 9. It has been found that the sonic oscillation of the fluid flow improves the removal of debris from the DE filter grid surfaces better than a solid stream or non-oscillating fluid flow that is exiting from a nozzle in close proximity to a DE filter grid surface. Herein, Close proximity means either touching or within ¼inch of the DE filter grid surface.

Referring to FIG. 11D, a side view 733 of the oscillator chamber side is shown. The side view is the same as the oscillator chamber side 736 shown in the second side view 734 of FIG. 10D. Near the bottom or entrance of the oscillator chamber side 736 is a sweeper which is shown in more detail in the detailed view of the sweeper 732 below the second side view 733. As discussed above, the sweeper 732 is designed to flex or crushed against the interior of the tubular extension when the quad output fluid oscillation nozzle 720 is inserted therein.

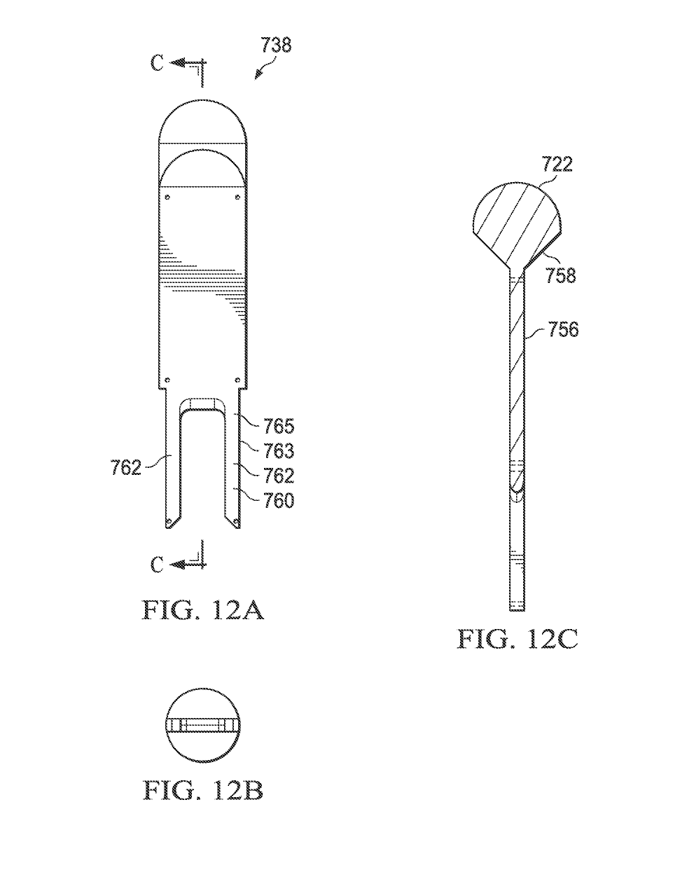

FIGS. 12A-12C is a multiview of the centerpiece 738, which is used to divide the two parallel fluid oscillation chambers and provide strength and stabilization to the overall nozzle structure. The top 722 provides a rounded surface such that entry between the DE filter grids is made easy. The top is also a solid material to provide strength and durability for when the tip strikes the ground or other hard surface. The center wall 756 has mainly smooth surfaces and divides the two parallel oscillation chambers formed on either side of the center wall 756 within the oscillator chamber side 736. The deflection surface 758 deflects or directs the oscillating waterflow toward the outputs of each of the oscillators such that an oscillating flow of fluid is angled from about 10° to 85° from a central axis of the overall fluid nozzle 720. The deflection angle shown for the deflection surface 758 is 45°.

A insertion portion strengthening portion 760 is established at the bottom of the centerpiece 738. The strengthening portion provides two thickened side beams 762 at the bottom of and on either side of the centerpiece 738. The thickened side beams 762 provide an outer surface 763 for the insertion portion 728 of the nozzle to be strengthened and a side surface 765 where the walls of the two side portions 736 are attached by, for example sonic welding, to the side beams 762.

The resulting quad output fluid oscillation novel nozzle 720 is a parallel two channel fluid oscillator nozzle wherein each channel comprises dual fluid oscillators in series and two output fluid vents. The output vents each produce alternating sonic oscillating fluid flow adapted to simultaneously pulse debris from the surfaces of two DE filter grids positioned next to each other within a vertical grid DE filter. Additionally, the outer surfaces of the embodiments of the nozzle and the tubular extension are contiguous and smooth when connected together in order to minimize abrasion or wear on the DE filter grid surfaces when the nozzle is being moved up and down and side to side between the filter grids installed in a filter grid assembly.

FIGS. 13A and 13B show a three-dimensional view and three-dimensional cutaway view of another embodiment of a DE transfer tube or DE drain extension tube 820. In this embodiment, the DE transfer tube 820 is threaded at both ends. At a first threaded end 822 of the transfer tube 820, the tube is dimensioned and threaded to screw into a 1½ inch PVC threaded fitting. At a second end 824 of the DE transfer tube 820, the tube is dimensioned and threaded to screw into a 2 inch PVC threaded fitting. The reason for the different size ends is so that the DE transfer tube 820 can be screwed into or fitted with a variety of standard size drain holes on various DE pool filter brands and models. A central tube portion 824 creates distance between the threaded ends 822, 824 or establishes the length of the DE transfer tube. The central tube portion 824 may be anywhere from a half inch to about 5 inches long. Between the central tube portion 824 and each of the two threaded end portions 822, 824 is a bag stop feature 826. The bag stop feature 826 comprises a portion that extends radially outward from the surface of the central tube portion 824. In this embodiment, the outer surface of the bag stop feature comprises a grip surface having ridges or bumps about its circumference to aid a user's grip when holding, installing or uninstalling the DE transfer tube 820 into or out of a drain hole of a DE pool filter. In this embodiment when one end of the DE transfer tube 820 is installed in a drain hole of a DE pool filter, the opening of the DE capture bag is slipped over the unused threads and the bag stop feature 826 at the other end of the DE transfer tube 820. The bag opening can then be clamped, tied or held via a hook and loop strip against the surface of the central tube portion 824.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus it is intended that the following claims be interpreted to embrace all such further modifications, changes, rearrangements, substitutions, alternatives, design choices, and embodiments.

1. A DE filter grid cleaning tool comprising:
an elongate tube having a distal end;
a spray nozzle attached to the distal end; the spray nozzle and elongate tube configured to be inserted and moved between two adjacent DE filter grids while the DE filter grids are installed in a DE filter grid assembly; the spray nozzle comprising:
a first fluid oscillation portion configured to oscillate a fluid moving there through such that the fluid is output from the spray nozzle with a sonic oscillation flow; and
the spray nozzle connects to the elongate tube such that an outer surface of the elongate tube and an outer surface of the spray nozzle are smooth and contiguous.

2. The DE filter grid cleaning tool of claim 1, further comprising a hand operated valve connected to a first end of the elongate tube, the hand operated valve configured to enable a user adjust a fluid flow rate through the spray nozzle.

3. The DE filter gird cleaning tool of claim 1, wherein the spray nozzle is further configured to output the oscillating fluid in a partial cone spray formation.

4. The DE filter grid cleaning tool of claim 1, wherein the first fluid oscillation portion comprises a first annular ring about the interior surface of the nozzle and having a central opening, a cylindrical portion and an output opening having a diameter that is smaller than the central opening, the cylindrical portion being between the annular ring and the output opening.

5. The DE filter grid cleaning tool of claim 4, wherein the length of the cylindrical portion is between one and three times an inner diameter of the elongate tube.

6. The DE filter grid cleaning tool of claim 1, wherein the spray nozzle further comprises a second fluid oscillation portion operating in parallel with the first fluid oscillation portion.

7. The DE filter grid cleaning tool of claim 1, wherein the fluid is output from the spray nozzle with a sonic oscillation flow proximate to a surface of one of the DE filter grids.

8. The DE filter grid cleaning tool of claim 1, wherein the fluid is output from the spray nozzle with a sonic oscillation flow proximate to a surface of each of the two adjacent DE filter grids.

9. A DE filter grid cleaning tool comprising:
an elongate tube having a distal end;
a spray nozzle attached to the distal end of the elongate tube, the spray nozzle comprising a fluid oscillator portion configured to oscillate a fluid moving there through at a sonic frequency when the fluid exits at least one fluid output port of the spray nozzle, the combination of the spray nozzle and elongate tube are configured to be inserted and moved between adjacent DE filter grids while the grids are installed in a DE Filter grid assembly, the combination of the elongate tube and the spray nozzle comprising a substantially smooth outer surface having no protrusion that may rub against the adjacent filter grids while the nozzle is inserted and moved between the adjacent filter grids.

10. The DE filter grid cleaning tool of claim 9, wherein the fluid oscillator portion comprises a first concave fluid obstruction having a first width and a second fluid oscillation obstruction having a second width, wherein the first width is narrower than the second width, the first concave and second concave obstruction being positioned in series within the fluid oscillator portion.

11. The DE filter grid cleaning tool of claim 9, wherein the fluid oscillator portion comprises:
a cylindrical portion;
a first annular ring positioned about an inner circumference of the cylindrical portion, the annular ring having a central opening; and
at least one output opening at a distal end of the spray nozzle, the output opening being centrally located at the distal end of the spray nozzle, the annular ring being spaced output opening by a distance that is from one to two times the diameter of the cylindrical portion; and the central opening of the annular ring being larger than the output opening.

12. The DE filter grid cleaning tool of claim 9, further comprising a hand operated valve connected to a first end of the elongate tube, the hand operated valve configured to enable a user adjust a fluid flow rate through the spray nozzle.

13. The DE filter grid cleaning tool of claim 9, wherein the fluid oscillator portion is configured to receive a flow of fluid and produce a plurality of sonic oscillating fluid flows at the output ports while the output ports are proximate to or in contact with a surface of one or both of the adjacent DE filter grids.

14. A DE filter DE capture system comprising:
a DE transfer tube configured to connect at a first end to a drain port of a DE filter, the DE transfer tube comprising a second end for allowing fluid comprising contaminated DE from inside the DE filter to exit, and a bag stop feature comprising a flange about the circumference of the DE transfer tube; and
a strainer bag comprised of a material configured to strain contaminated DE from the fluid, the strainer bag having an opening configured to fit over the second end and the bag stop feature; and
a holder for holding the opening against the DE transfer tube, the holder being placed about the outside of the strainer bag and adjacent to the opening and between the flange and the first end of the DE transfer tube.

15. The DE filter capture system wherein the first end comprises a threaded portion that is either 1½ inches in diameter or 2 inches in diameter, the threaded portion being for attaching the DE transfer tube to the drain port of the DE filter.

16. The DE filter capture system of claim 14, wherein the flange further comprises graspable arcuate portions about the outer perimeter of the flange.
